(19) United States
(12) Patent Application Publication
(10) Pub. No.: US 2026/0203617 A1
(43) Pub. Date: Jul. 16, 2026

(54) SYSTEM AND METHOD FOR PERFORMING EDGE LEVEL INFERENCE

(71) Applicant: JIO PLATFORMS LIMITED, Ahmedabad (IN)

(72) Inventors: Aayush BHATNAGAR, Navi Mumbai (IN); Ankit MURARKA, Navi Mumbai (IN); Jugal KISHORE, Navi Mumbai (IN); Chandra GANVEER, Navi Mumbai (IN); Sanjana CHAUDHARY, Navi Mumbai (IN); Gourav GURBANI, Navi Mumbai (IN); Yogesh KUMAR, Navi Mumbai (IN); Avinash KUSHWAHA, Navi Mumbai (IN); Dharmendra Kumar VISHWAKARMA, Navi Mumbai (IN); Sajal SONI, Navi Mumbai (IN); Niharika PATNAM, Navi Mumbai (IN); Shubham INGLE, Navi Mumbai (IN); Harsh PODDAR, Navi Mumbai (IN); Sanket KUMTHEKAR, Navi Mumbai (IN); Mohit BHANWRIA, Navi Mumbai (IN); Shashank BHUSHAN, Navi Mumbai (IN); Vinay GAYKI, Navi Mumbai (IN); Durgesh KUMAR, Navi Mumbai (IN); Aniket KHADE, Navi Mumbai (IN); Zenith KUMAR, Navi Mumbai (IN); Gaurav KUMAR, Navi Mumbai (IN); Manasvi RAJANI, Navi Mumbai (IN); Kishan SAHU, Navi Mumbai (IN); Sunil MEENA, Navi Mumbai (IN); Supriya Kaushik DE, Navi Mumbai (IN); Kumar DEBASHISH, Navi Mumbai (IN); Mehul TILALA, Navi Mumbai (IN); Satish NARAYAN, Navi Mumbai (IN); Rahul KUMAR, Navi Mumbai (IN); Harshita GARG, Navi Mumbai (IN); Kunal TELGOTE, Navi Mumbai (IN); Ralph LOBO, Navi Mumbai (IN); Girish DANGE, Navi Mumbai (IN)

(73) Assignee: JIO PLATFORMS LIMITED, Ahmedabad (IN)

(21) Appl. No.: 19/526,021

(22) PCT Filed: Oct. 6, 2024
(86) PCT No.: PCT/IN2024/051975

§ 371 Date: Apr. 5, 2026

(30) Foreign Application Priority Data
Oct. 6, 2023 (IN) 202321067260

(51) Int. Cl. G06N 5/04

(52) U.S. Cl. CPC G06N 5/04

(57) ABSTRACT

The present disclosure relates to a system and method for performing edge level inference is disclosed. The system includes a training unit to train, a plurality of models with historic data of one or more resources. The system includes a deploying unit to deploy, the one or more trained models onto one or more edge devices. The system includes a transceiver to receive, at the one or more edge devices, real time data which is required to be inferenced. The system includes an inference engine to inference, utilizing the one or more trained models, at the one or more edge devices, one or more events based on the real time data received.

### CROSS REFERENCE TO RELATED APPLICATIONS

This is the U.S. National Stage of International Application No. PCT/IN2024/051975, filed on Oct. 6, 2024, which was published in English under PCT Article 21(2), which in turn claims the benefit of India Application No. 202321067260, filed in India on Oct. 6, 2023. The applications are hereby incorporated herein in their entirety.

### FIELD OF TECHNOLOGY

The present disclosure generally relates to the field of wireless communication networks, more particularly to a system and method for performing edge level inference.

### BACKGROUND

With the increase in number of users, the network service provisions have been implemented for upgradations to enhance the service quality so as to keep pace with such high demand. With advancement of technology, there is a demand for the telecommunication service to induce up-to-date features into the scope of provision. To enhance user experience and implement advanced monitoring mechanisms, prediction methodologies are being incorporated in the network management. An advanced prediction system integrated with an AI/ML system excels in executing a wide array of algorithms and predictive tasks.

An edge-level inference hosting, also known as on-device inference hosting or edge deployment of machine learning models, refers to the practice of deploying and running machine learning models directly on edge devices or at the edge of a network.

The traditional system with integrated AI/ML technology performs predictions using the centralized server bundle which are to be transferred to the edge devices of the network such as network nodes and network performance management entities. This process of inference data transfer takes significant time and bandwidth usage.

### SUMMARY

One or more embodiments of the present disclosure provide a method and system for performing edge level inference.

Inone aspect, a method for performing the edge level inference is disclosed. The method includes the step of training, by one or more processors, a plurality of models with historic data of one or more resources of at least one of, centralized servers or edge servers. The method includes the step of deploying, by the one or more processors, the one or more trained models onto one or more edge devices. The method includes the step of receiving, by the one or more processors, at the one or more edge devices, real time data which is required to be inferenced. The method includes the step of inferencing, by the one or more processors, utilizing the one or more trained models, at the one or more edge devices, one or more events based on the received real time data.

In one embodiment, the historic data pertains to at least one performance data, one or more resource utilization, and trends/patterns.

In yet another embodiment, the step of deploying, the one or more trained models onto corresponding one or more edge devices as per the categorized one or more network use cases, includes the steps of identifying, by the one or more processors, the one or more attributes of the historic data of the one or more trained models. The step of deploying, the one or more trained models onto corresponding one or more edge devices as per the categorized one or more network use cases, includes the steps of checking, by the one or more processors, whether the one or more attributes of the historic data of the one or more trained models are present with the one or more edge devices. The step of deploying, the one or more trained models onto corresponding one or more edge devices as per the categorized one or more network use cases, includes the steps of deploying, by the one or more processors, the one or more trained models onto the one or more edge devices based on the identification in response to determining that the one or more attributes are present with the one or more edge devices.

In yet another embodiment, each of the plurality of models are trained with trends/patterns of the historic data.

In yet another embodiment, the one or more events inferenced include at least one of, detecting one or more anomalies with the real time data or predicting/forecasting one or more future anomalies.

In yet another embodiment, the method further includes the steps of synchronizing, by the one or more processors, the one or more trained models deployed onto the one or more edge devices with a centralized system. The method further includes the steps of updating, by the one or more processors, the one or more trained models with updated historic data which is retrieved from the centralized system.

In yet another embodiment, the one or more trained models updated with the historic data in real time.

In yet another embodiment, the centralized servers are part of a server bundle.

In another aspect, a system for performing edge level inference is disclosed. The system includes a training unit, configured to train, a plurality of models with historic data of one or more resources of at least one of, centralized servers or edge servers. The system includes a deploying unit, configured to deploy, the one or more trained models on one or more edge devices. The system includes a transceiver, configured to, receive, at the one or more edge devices, real time data which is required to be inferenced. The system includes an inference engine, configured to inference, utilizing the one or more trained models, at the one or more edge devices, one or more events based on the received real time data.

In yet another aspect, a non-transitory computer-readable medium stored thereon computer-readable instructions that, when executed by a processor, is disclosed. The processor is configured to train a plurality of models with historic data of one or more resources of at least one of, centralized servers or edge servers. The processor is configured to deploy the one or more trained models onto one or more edge devices. The processor is configured to receive at the one or more edge devices, real time data which is required to be inferenced. The processor is configured to inference utilizing the one or more trained models, at the one or more edge devices, one or more events based on the received real time data.

Other features and aspects of the present disclosure will be apparent from the following description and the accompanying drawings. The features described in this summary are not all-inclusive, and particularly, many additional features and advantages will be apparent to one of ordinary skill in the relevant art, in view of the drawings, specification, and claims hereof. Moreover, it should be noted that the language used in the specification has been principally selected for readability and instructional purposes and may not have been selected to delineate or circumscribe the inventive subject matter, resort to the claims being necessary to determine such inventive subject matter.

### BRIEF DESCRIPTION OF THE DRAWINGS

The accompanying drawings, which are incorporated herein, and constitute a part of this disclosure, illustrate exemplary embodiments of the disclosed methods and systems in which reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 is an exemplary block diagram of an environment for performing edge level inference, according to one or more embodiments.

FIG. 2 is an exemplary block diagram of a system for performing the edge level inference, according to the one or more embodiments.

FIG. 3 is a block diagram of an architecture that can be implemented in the system of FIG. 2, according to the one or more embodiments.

FIG. 4 is a block diagram illustrates performing the edge level inference, according to the one or more embodiments.

FIG. 5 is a flow diagram illustrating a method for performing the edge level inference, according to the one or more embodiments.

The foregoing shall be more apparent from the following detailed description.

### DETAILED DESCRIPTION

Some embodiments of the present disclosure, illustrating all its features, will now be discussed in detail. It must also be noted that as used herein and in the appended claims, the singular forms “a”, “an” and “the” include plural references unless the context clearly dictates otherwise.

Various modifications to the embodiment will be readily apparent to those skilled in the art and the generic principles herein may be applied to other embodiments. However, one of the ordinary skill in the art will readily recognize that the present disclosure including the definitions listed here below are not intended to be limited to the embodiments illustrated but is to be accorded the widest scope consistent with the principles and features described herein.

A person of ordinary skill in the art will readily ascertain that the illustrated steps detailed in the figures and here below are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

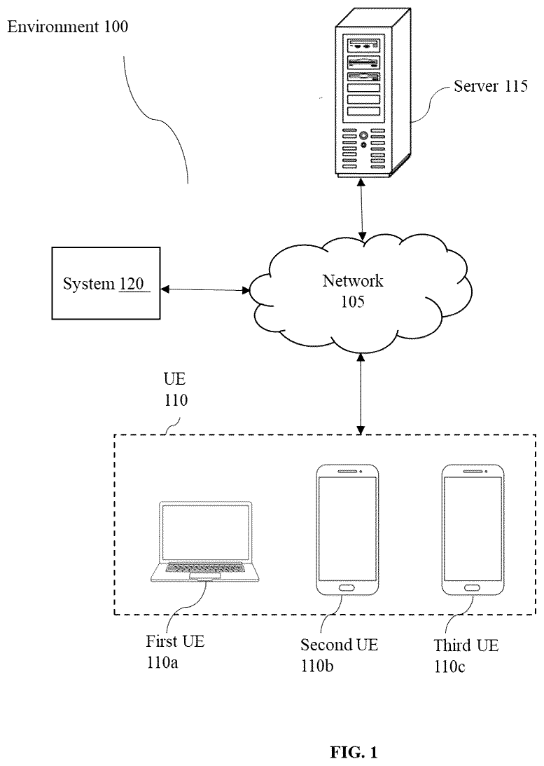

FIG. 1 illustrates an exemplary block diagram of an environment 100 for performing edge level inference, according to one or more embodiments. The environment 100 includes a network 105, a User Equipment (UE) 110, a server 115, and a system 120. The UE 110 aids a user to interact with the system 120 for performing the edge level inference. In an embodiment, the user is at least one of, a network operator, and a service provider. The edge level inference refers to the process of performing data analysis and making predictions directly on edge devices, such as sensors, gateways, or IoT devices, rather than relying on centralized cloud services. This approach leverages the computational capabilities of devices located at the edge of the network 105, allowing for quicker responses and reduced latency.

For the purpose of description and explanation, the description will be explained with respect to the UE 110, or to be more specific will be explained with respect to a first UE 110a, a second UE 110b, and a third UE 110c, and should nowhere be construed as limiting the scope of the present disclosure. Each of the UE 110 from the first UE 110a, the second UE 110b, and the third UE 110c is configured to connect to the server 115 via the network 105. In an embodiment, each of the first UE 110a, the second UE 110b, and the third UE 110c is one of, but not limited to, any electrical, electronic, electro-mechanical or an equipment and a combination of one or more of the above devices such as smartphones, virtual reality (VR) devices, augmented reality (AR) devices, laptop, a general-purpose computer, desktop, personal digital assistant, tablet computer, mainframe computer, or any other computing device.

The network 105 includes, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof. The network 105 may include, but is not limited to, a Third Generation (3G), a Fourth Generation (4G), a Fifth Generation (5G), a Sixth Generation (6G), a New Radio (NR), a Narrow Band Internet of Things (NB-IoT), an Open Radio Access Network (O-RAN), and the like.

The server 115 may include by way of example but not limitation, one or more of a standalone server, a server blade, a server rack, a bank of servers, a server farm, hardware supporting a part of a cloud service or system, a home server, hardware running a virtualized server, one or more processors executing code to function as a server, one or more machines performing server-side functionality as described herein, at least a portion of any of the above, some combination thereof. In an embodiment, the entity may include, but is not limited to, a vendor, a network operator, a company, an organization, a university, a lab facility, a business enterprise, a defense facility, or any other facility that provides content.

The environment 100 further includes the system 120 communicably coupled to the server 115 and each of the first UE 110a, the second UE 110b, and the third UE 110c via the network 105. The system 120 is configured for performing the edge level inference. The system 120 is adapted to be embedded within the server 115 or is embedded as the individual entity, as per multiple embodiments of the present disclosure.

Operational and construction features of the system 120 will be explained in detail with respect to the following figures.

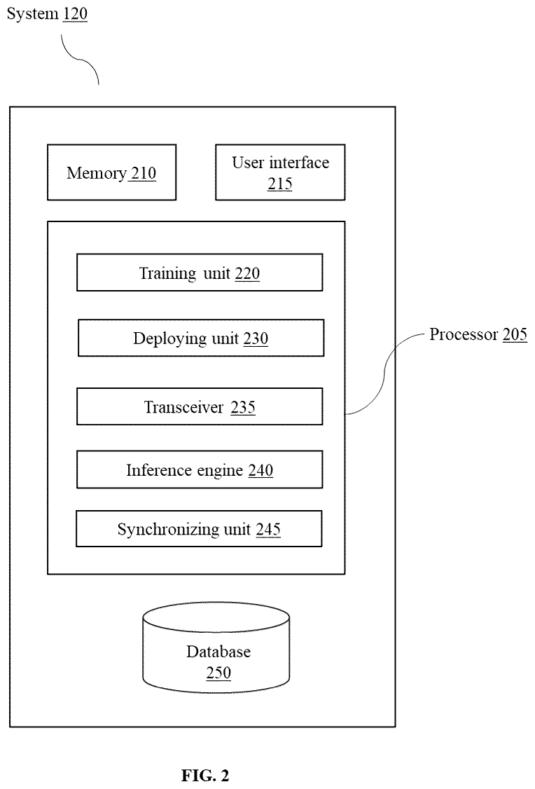

FIG. 2 is an exemplary block diagram of a system 120 for performing the edge level inference, according to one or more embodiments.

The system 120 includes a processor 205, a memory 210, a user interface 215, and a database 250. For the purpose of description and explanation, the description will be explained with respect to one or more processors 205, or to be more specific will be explained with respect to the processor 205 and should nowhere be construed as limiting the scope of the present disclosure. The one or more processors 205, hereinafter referred to as the processor 205 may be implemented as one or more microprocessors, microcomputers, microcontrollers, digital signal processors, central processing units, state machines, logic circuitries, single board computers, and/or any devices that manipulate signals based on operational instructions.

As per the illustrated embodiment, the processor 205 is configured to fetch and execute computer-readable instructions stored in the memory 210. The memory 210 may be configured to store one or more computer-readable instructions or routines in a non-transitory computer-readable storage medium, which may be fetched and executed to create or share data packets over a network service. The memory 210 may include any non-transitory storage device including, for example, volatile memory such as RAM, or non-volatile memory such as EPROM, flash memory, and the like.

The User Interface (UI) 215 includes a variety of interfaces, for example, interfaces for a Graphical User Interface (GUI), a web user interface, a Command Line Interface (CLI), and the like. The user interface 215 facilitates communication of the system 120. In one embodiment, the user interface 215 provides a communication pathway for one or more components of the system 120. Examples of the one or more components include, but are not limited to, the UE 110, and the database 250.

The database 250 is one of, but not limited to, a centralized database, a cloud-based database, a commercial database, an open-source database, a distributed database, an end-user database, a graphical database, a No-Structured Query Language (NoSQL) database, an object-oriented database, a personal database, an in-memory database, a document-based database, a time series database, a wide column database, a key value database, a search database, a cache databases, and so forth. The foregoing examples of database 250 types are non-limiting and may not be mutually exclusive e.g., a database can be both commercial and cloud-based, or both relational and open-source, etc.

Further, the processor 205, in an embodiment, may be implemented as a combination of hardware and programming (for example, programmable instructions) to implement one or more functionalities of the processor 205. In the examples described herein, such combinations of hardware and programming may be implemented in several different ways. For example, the programming for the processor 205 may be processor-executable instructions stored on a non-transitory machine-readable storage medium and the hardware for processor 205 may include a processing resource (for example, one or more processors), to execute such instructions. In the present examples, the memory 210 may store instructions that, when executed by the processing resource, implement the processor 205. In such examples, the system 120 may include the memory 210 storing the instructions and the processing resource to execute the instructions, or the memory 210 may be separate but accessible to the system 120 and the processing resource. In other examples, the processor 205 may be implemented by electronic circuitry.

In order for the system 120 to perform edge level inference, the processor 205 includes a training unit 220, a categorizing unit 225, a deploying unit 230, a transceiver 235, an inference engine unit 240, and a synchronizing unit 245 can be used in combination 205 communicably coupled to each other. In an embodiment, operations and functionalities of the training unit 220, the categorizing unit 225, the deploying unit 230, the transceiver 235, the inference engine unit 240, and the synchronizing unit 245 can be used in combination or interchangeably.

The training unit 220 is configured to train a plurality of models with historic data of one or more resources. In an embodiment, the one or more resources is at least one of centralized servers or edge servers. The centralized servers aggregate the data from one or more sources, providing a comprehensive view of training the plurality of models. The data includes large datasets, facilitating more complex models. The edge servers process the data generated in real-time, enabling immediate insights and actions based on current conditions. The training unit 220 uses the historic data to train the models. In an embodiment, each of the plurality of models are trained with trends/patterns of the historic data. In an embodiment, the historic data pertains to at least one of, performance data. The performance data includes one or more metrics to analyse inform predictive analytics and optimization strategies. In an embodiment, the one or more metrics include, but not limited to, CPU usage, memory consumption, response times, error rates, and more. Analyzing the one or more metrics can help identify trends and predict future performance. The trends refer to long-term increases or decreases in performance metrics. The pattern refers to time series analysis to uncover repeating patterns or cycles, and clustering algorithms to group similar historical events or states.

Upon training the plurality of models with historic data, the deploying unit 230 is configured to deploy the one or more trained models onto the one or more edge devices. The deploying unit 230 is configured to identify the one or more attributes of the one or more trained models. The deploying unit 230 evaluates the one or more attributes such as accuracy, latency, resource consumption to determine the one or more trained models. Each model of the one or more trained models is analyzed to ensure compatibility with the one or more edge devices. The deploying unit 230 ensures that the identified attributes align with the operational needs of the deployment scenario. In an exemplary embodiment, one or more attributes of a first trained model has an accuracy of 92%, and one or more attributes of a second trained model has an accuracy of 85%, Based on the exemplary embodiment, the one or more attributes of the first trained model performs better overall. The one or more trained models are compared with the capabilities and operational contexts of the one or more edge devices. The identified one or more edge devices are configured to handle the specific tasks or applications for which the models have been trained. Once the suitable one or more edge devices have been identified, the deploying unit 230 is configured to check whether the one or more attributes of the one or more trained models are present with the one or more edge devices.

The deploying unit 230 securely transmits the one or more trained models to the identified one or more edge devices, using protocols that ensure data integrity and security (e.g., Transport Layer Security (TLS)/Secure Socket Layer (SSL)). The deploying unit 230 maintains or accesses a list of available edge devices within the network 105. The deploying unit 230 is configured to deploy the one or more trained models onto the one or more edge devices in response to determining that the one or more attributes are present with the one or more edge devices. The deploying unit 230 can compare the data schema of incoming data from the one or more edge devices against the one or more trained models. The deploying unit 230 establishes a mapping between the one or more attributes and those generated by the one or more edge devices. The deploying unit 230 continuously monitors the data stream from the one or more edge devices to check for expected one or more attributes and utilizes the one or more trained models itself to check for the one or more attributes presence indirectly. In an exemplary embodiment, the deploying unit 230 compares the one or more attributes of each model with the capabilities of the one or more edge devices. The first trained model of the one or more trained models initiates to deploy on the one or more edge devices. After deployment, the deploying unit 230 may perform checks and validations to ensure that the one or more trained models are correctly installed and function as expected. The deploying unit 230 assesses the one or more attributes of the one or more trained models against the one or more edge devices to make informed deployment decisions. This systematic approach ensures that the one or more trained models are effectively utilized in environments where they can perform optimally. By deploying the one or more trained models only to the identified one or more edge devices, the system 120 optimizes the use of available resources and reduces the risk of overloading devices.

Upon deploying the one or more trained models onto the one or more edge devices, the transceiver 235 configured to receive real time data which is required to be inferenced at the one or more edge devices. The transceiver 235 facilitates real-time data acquisition, allowing the system 120 to react promptly to new information. The transceiver 235 is responsible for handling different data formats and ensuring that the incoming data is standardized for processing. The transceiver 235 also validates the incoming data to check for accuracy, completeness, and relevance before passing the incoming data to the inference engine 240. Once the real time data is received and validated, the transceiver 235 forwards the real time data to the inference engine 240. By facilitating immediate data reception, the transceiver 235 enables the system to perform real-time inferences, enhancing responsiveness.

Upon receiving the real time data which is required to be inferenced at the one or more edge devices, the inference engine 240 is configured to inference one or more events based on the received real time data at the one or more edge devices by utilizing the one or more trained models. The real time data received is crucial for making real-time inferences. The inference engine 240 selects the appropriate trained model(s) that corresponds to the real time data. Before inference, the received real time data needs to be preprocessed to match the format expected by the one or more trained models. The inference engine 240 executes the inference process by applying the trained model(s) to the preprocessed real time data. The inference engine 240 produces one or more outputs. In an embodiment, the one or more outputs include, but not limited to, predicted values, and categories of detected anomalies.

In one embodiment, the one or more outputs generated by the inference engine 240 are interpreted to identify one or more events. In an embodiment, the one or more events inferenced include at least one of, detecting one or more anomalies with the real time data or predicting/forecasting one or more future anomalies. The real time data is analyzed in real-time to identify any data points that fall outside established thresholds or patterns. If the one or more anomalies are detected, the inference engine 240 generates the one or more events indicating a type of anomaly, severity or confidence level of the detection. The inference engine 240 processes the real time data along with historical trends to generate forecasts of the one or more future anomalies. By enabling immediate inferences from real time data, the inference engine 240 supports real-time decision-making, crucial for applications such as predictive maintenance or anomaly detection.

Upon inferencing the one or more events based on the received real time data, the synchronizing unit 245 begins by checking the status of the one or more trained models. The synchronizing unit 245 is configured to synchronize the one or more trained models deployed onto the one or more edge devices with a centralized system. The synchronizing unit 245 establishes a secure connection with the centralized system to facilitate data exchange, which involves using Application Programming Interfaces (APIs) or other communication protocols to ensure a reliable link. The synchronizing unit 245 retrieves updated historical data from the centralized system. In an embodiment, the updated historical data includes additional training data that reflects changes in the environment or usage patterns. Once the updated historical data is retrieved, the synchronizing unit 245 is configured to update the one or more trained models with updated historic data. The updated historic data is retrieved from the centralized system. The one or more deployed models are updated periodically by synchronizing with the centralized system in order to learn the current network conditions and provide precise network predictions in real-time.

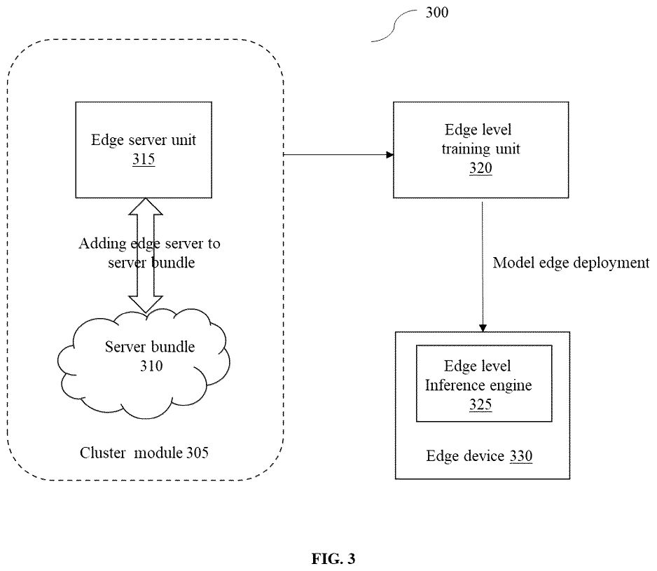

FIG. 3 is a block diagram of an architecture 300 that can be implemented in the system of FIG. 2, according to one or more embodiments. The architecture 300 of the system 120 includes a cluster module 305, includes a server bundle 310 and an edge server unit 315, an edge level training unit 320, an edge level inference engine 325 and an edge device 330.

The cluster module 305 is a software or hardware component responsible for managing a cluster of interconnected computers or nodes that work together to perform tasks as a single system. The cluster module 305 includes load balancing, resource allocation, fault tolerance, and communication between the nodes. The cluster module 305 includes the server bundle 310 and the edge server unit 315. The server bundle 310 is the system's own centralized cluster resource using which ML model training is done. The server bundle 310 consists of the hardware server stack on which the system is working. The edge server unit 315 is one of a third party/Network Function (NF) cluster/user server that is at the edge of the network 105. The edge server usually has limited storage and memory resource which is why trained models are compressed and deployed on these servers. The edge server unit 315 is added to the server bundle 310.

The edge level training unit 320 is responsible for edge level training and then deployment of the one or more trained models on the corresponding one or more edge devices 330. The edge level training unit 320 internally performs historic data pre-processing, feature selection, hyper parameter configuration, train test split and then finally model training. The data pre-processing is performed in the edge level inference engine 325.

The edge level inference engine 325 is responsible for the steps involved in data pre-processing of real time input data and edge level inference hosting. The real-time input data is fed to the model for prediction of future performance data such as KPIs, alarms, counters and clear code count. Once the model is trained, the trained one or more models are deployed onto the corresponding one or more edge devices 330. The one or more edge devices 330 generates real-time insights and analytics at the edge, which are performed by analyzing and processing inference results, enabling local decision-making and actions.

The system 120 is configured to interact with an external and internal data source. The system includes one or more databases and is capable of interacting with one or more application servers in the network 105. The system 120 may also employ a parameter selection mechanism incorporated into the system. The system 120 is configured to interact with various components of the network 105 and external network by means of various APIs, databases and servers or any other compatible element. The databases/data lakes are configured to store past data, dynamic data, and trained models for future necessity.

The system 120 is further configured to incorporate even more data into pre-processing steps if required to refine the data analysis. The pre-processing step involves extracting and normalizing the data by applying suitable operation filter, normalization, cleaning and standardization of data. The system 120 is configured to interact with the application servers, Integrated Performance Management (IPM), Fulfillment Management System (FMS), Network Management System (NMS) modules in the network 105 via the API as medium of communication and may perform the process by means of various formats like JavaScript Object Notation (JSON), Python or any other compatible formats.

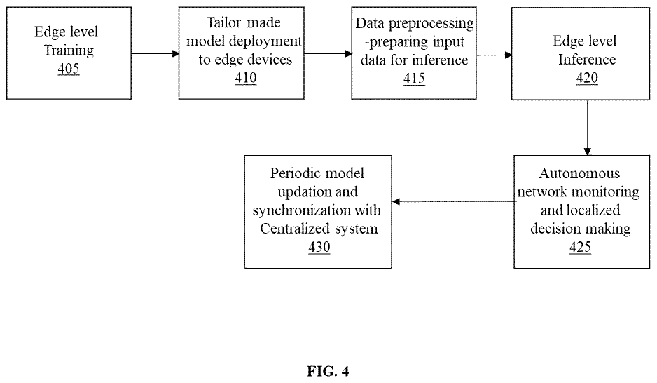

FIG. 4 is a block diagram illustrating performing the edge level inference, according to the one or more embodiments.

At 405, the training unit 220 is configured to train the plurality of models with historic data of one or more resources. In an embodiment, the one or more resources is at least one of centralized servers or edge servers. The training unit 220 uses the historic data to train the models. In an embodiment, the historic data pertains to at least one of, performance data, one or more resource utilizations, and trends/patterns. The performance data includes one or more metrics to analyse inform predictive analytics and optimization strategies. In an embodiment, the one or more metrics include, but not limited to, CPU usage, memory consumption, response times, error rates, and more. Analyzing the one or more metrics can help identify trends and predict future performance.

At 410, upon training the plurality of models with the historic data, the deploying unit 230 is configured to deploy the one or more trained models onto the corresponding one or more edge devices. The deploying unit 230 is configured to identify the one or more attributes of the historic data of the one or more trained models. The historic data contains inconsistencies, which can obscure true attribute relationships. If the deploying unit 230 identifies too many attributes that seem significant based on historical data, there's a risk of overfitting, where the model performs well on past data. The identified one or more edge devices are configured to handle the specific tasks or applications for which the models have been trained. Once the suitable one or more edge devices have been identified, the deploying unit 230 is configured to check whether the one or more attributes of the historic data of the one or more trained models are present with the one or more edge devices. The deploying unit 230 can compare the data schema of incoming data from the one or more edge devices against the schema of the historical data. The deploying unit 230 establishes the mapping between attributes in the historical data and those generated by the one or more edge devices. The deploying unit 230 continuously monitors the data stream from the one or more edge devices to check for expected attributes and utilizes the one or more trained models itself to check for the one or more attributes presence indirectly.

The deploying unit 230 securely transmits the models to the identified one or more edge devices, using protocols that ensure data integrity and security (e.g., Transport Layer Security (TLS)/Secure Socket Layer (SSL)). The deploying unit 230 maintains or accesses a list of available edge devices within the network 105. The deploying unit 230 is configured to deploy the one or more trained models onto the one or more edge devices based on the identification. After deployment, the deploying unit 230 may perform checks to ensure that the trained models are correctly installed and function as expected. By deploying the trained models only to the identified one or more edge devices that match the one or more network use cases, the system 120 optimizes the use of available resources and reduces the risk of overloading devices.

At 415, upon deploying the one or more trained models onto the corresponding one or more edge devices, the transceiver 235 configured to receive real time data which is required to be inferenced at the one or more edge devices. The transceiver 235 facilitates real-time data acquisition, allowing the system 120 to react promptly to new information. The transceiver 235 is responsible for handling different data formats and ensuring that the incoming data is standardized for processing. The transceiver 235 also validates the incoming data to check for accuracy, completeness, and relevance before passing the incoming data to the inference engine 240. Once the real time data is received and validated, the transceiver 235 forwards the real time data to the inference engine 240. By facilitating immediate data reception, the transceiver 235 enables the system to perform real-time inferences, enhancing responsiveness.

At 420, upon receiving the real time data which is required to be inferenced at the one or more edge devices, the inference engine 240 is configured to inference one or more events based on the received real time data at the one or more edge devices by utilizing the one or more trained models. The real time data received is crucial for making real-time inferences. The inference engine 240 selects the appropriate trained model(s) that corresponds to the real time data. Before inference, the received real time data needs to be preprocessed to match the format expected by the trained models. The inference engine 240 executes the inference process by applying the trained model(s) to the preprocessed real time data. The inference engine 240 produces one or more outputs. In an embodiment, the one or more outputs include, but not limited to, predicted values, and categories of detected anomalies.

At 425, in one embodiment, the one or more outputs generated by the inference engine 240 are interpreted to identify one or more events. In an embodiment, the one or more events inferenced include at least one of, detecting one or more anomalies with the real time data or predicting/forecasting one or more future anomalies. The real time data is analyzed in real-time to identify any data points that fall outside established thresholds or patterns. If the one or more anomalies are detected, the inference engine 240 generates the one or more events indicating a type of anomaly, severity or confidence level of the detection. The inference engine 240 processes the real time data along with historical trends to generate forecasts of the one or more future anomalies. By enabling immediate inferences from real time data, the inference engine 240 supports autonomous network monitoring and real-time decision-making, crucial for applications such as predictive maintenance or anomaly detection.

At 430, upon inferencing the one or more events based on the received real time data, the synchronizing unit 245 is configured to synchronize the one or more trained models deployed onto the one or more edge devices with the centralized system. The synchronizing unit 245 establishes the secure connection with the centralized system to facilitate data exchange, which involves using Application Programming Interfaces (APIs) or other communication protocols to ensure a reliable link. The synchronizing unit 245 retrieves updated historical data from the centralized system. In an embodiment, the updated historical data includes additional training data that reflects changes in the environment or usage patterns. Once the updated historical data is retrieved, the synchronizing unit 245 is configured to update the one or more trained models with updated historic data. In an embodiment, the one or more trained models are updated with the historic data in real time. The updated historic data is retrieved from the centralized system. The one or more deployed models are updated periodically by synchronizing with the centralized system in order to learn the current network conditions and provide precise network predictions. The periodic one or more deployed models updating is performed in different frequencies and in real time.

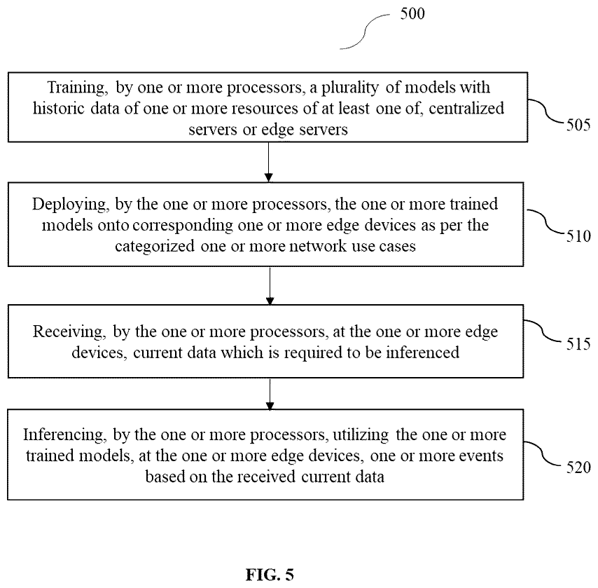

FIG. 5 is a flow diagram illustrating a method for performing the edge level inference, according to one or more embodiments.

At step 505, the method 500 includes the step of training the plurality of models with historic data of one or more resources by the training unit 220. In an embodiment, the one or more resources is at least one of centralized servers or edge servers. The centralized servers aggregate the data from one or more sources, providing a comprehensive view of training the plurality of models. The data includes large datasets, facilitating more complex models. The edge servers process the data generated in real-time, enabling immediate insights and actions based on current conditions. The training unit 220 uses the historic data to train the models. In an embodiment, the historic data pertains to at least one of, performance data, one or more resource utilization, and trends/patterns. The performance data includes one or more metrics to analyse inform predictive analytics and optimization strategies. In an embodiment, the one or more metrics include, but not limited to, CPU usage, memory consumption, response times, error rates, and more. Analyzing the one or more metrics can help identify trends and predict future performance.

At step 515, the method 500 includes the step of deploying the one or more trained models onto the corresponding one or more edge devices by the deploying unit 230. The deploying unit 230 is configured to identify the one or more attributes of the historic data of the one or more trained models. The historic data contains inconsistencies, which can obscure true attribute relationships. If the deploying unit 230 identifies too many attributes that seem significant based on historical data, there's a risk of overfitting, where the model performs well on past data. The one or more network use cases of the trained model are compared with the capabilities and operational contexts of the one or more edge devices. The identified one or more edge devices are configured to handle the specific tasks or applications for which the models have been trained. Once the suitable one or more edge devices have been identified, the deploying unit 230 is configured to check whether the one or more attributes of the historic data of the one or more trained models are present with the one or more edge devices. The deploying unit 230 can compare the data schema of incoming data from the one or more edge devices against the schema of the historical data. The deploying unit 230 establishes the mapping between attributes in the historical data and those generated by the one or more edge devices. The deploying unit 230 continuously monitors the data stream from the one or more edge devices to check for expected attributes and utilizes the one or more trained models itself to check for the one or more attributes presence indirectly.

The deploying unit 230 securely transmits the models to the identified one or more edge devices, using protocols that ensure data integrity and security (e.g., Transport Layer Security (TLS)/Secure Socket Layer (SSL)). The deploying unit 230 maintains or accesses a list of available edge devices within the network 105. The deploying unit 230 is configured to deploy the one or more trained models onto the one or more edge devices based on the identification in response to determining that the one or more attributes are present with the one or more edge devices. After deployment, the deploying unit 230 may perform checks to ensure that the trained models are correctly installed and function as expected. The system 120 optimizes the use of available resources and reduces the risk of overloading devices.

At step 520, the method 500 includes the step of receiving real time data which is required to be inferenced at the one or more edge devices by the transceiver 235. The transceiver 235 facilitates real-time data acquisition, allowing the system 120 to react promptly to new information. The transceiver 235 is responsible for handling different data formats and ensuring that the incoming data is standardized for processing. The transceiver 235 also validates the incoming data to check for accuracy, completeness, and relevance before passing the incoming data to the inference engine 240. Once the real time data is received and validated, the transceiver 235 forwards the real time data to the inference engine 240. By facilitating immediate data reception, the transceiver 235 enables the system to perform real-time inferences, enhancing responsiveness.

At step 525, the method 500 includes the step of inferencing the one or more events based on the received real time data at the one or more edge devices by utilizing the one or more trained models by the inference engine 240. The real time data received is crucial for making real-time inferences. The inference engine 240 selects the appropriate trained model(s) that corresponds to the real time data. Before inference, the received real time data needs to be preprocessed to match the format expected by the trained models. The inference engine 240 executes the inference process by applying the trained model(s) to the preprocessed real time data. The inference engine 240 produces one or more outputs. In an embodiment, the one or more outputs include, but not limited to, predicted values, and categories of detected anomalies.

In one embodiment, the one or more outputs generated by the inference engine 240 are interpreted to identify one or more events. In an embodiment, the one or more events inferenced include at least one of, detecting one or more anomalies with the real time data or predicting/forecasting one or more future anomalies. The real time data is analyzed in real-time to identify any data points that fall outside established thresholds or patterns. If the one or more anomalies are detected, the inference engine 240 generates the one or more events indicating a type of anomaly, severity or confidence level of the detection. The inference engine 240 processes the real time data along with historical trends to generate forecasts of the one or more future anomalies. By enabling immediate inferences from the real time data, the inference engine 240 supports real-time decision-making, crucial for applications such as predictive maintenance or anomaly detection.

In another aspect of the embodiment, a non-transitory computer-readable medium stored thereon computer-readable instructions that, when executed by a processor 205 is disclosed. The processor 205 is configured to train a plurality of models with historic data of one or more resources of at least one of, centralized servers or edge servers. The processor 205 is configured to categorize one or more trained models out of the plurality of trained models. The processor 205 is configured to deploy the one or more trained models onto one or more edge devices. The processor 205 is configured to receive at the one or more edge devices, real time data which is required to be inferenced. The processor 205 is configured to inference utilizing the one or more trained models, at the one or more edge devices, one or more events based on the real time data received.

A person of ordinary skill in the art will readily ascertain that the illustrated embodiments and steps in description and drawings (FIGS. 1-5) are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

The present disclosure provides technical advancement for deploying the one or more trained models onto corresponding one or more edge devices as per the categorized one or more network use cases. The present disclosure provides a system and method thereof to perform required prediction and inference data transfer optimally without consuming too much time or bandwidth. The present system is configured to perform predictions at the edge of the server by deploying the one or more trained models and performing edge level training using user servers or NF cluster servers to train the model. Further, the present system is configured to implement customized models for the specific use case and deploy locally on the corresponding one or more edge devices thus leveraging autonomous network monitoring and making localized decisions across the network in a distributed manner.

What is claimed is:

1. A method for performing edge level inference, the method comprising:
training, by one or more processors, a plurality of models with historic data of one or more resources of at least one of, centralized servers or edge servers;
deploying, by the one or more processors, the one or more trained models onto one or more edge devices;
receiving, by the one or more processors, at the one or more edge devices, real time data which is required to be inferenced; and
inferencing, by the one or more processors, utilizing the one or more trained models, at the one or more edge devices, one or more events based on the real time data received.

2. The method of claim 1, wherein the historic data pertains to at least one of, performance data, one or more resource utilizations, and trends/patterns.

3. The method of claim 1, wherein, deploying the one or more trained models onto the corresponding one or more edge devices, comprises:
identifying, by the one or more processors, one or more attributes of the one or more trained models;
checking, by the one or more processors, whether the one or more attributes of the one or more trained models are present with the one or more edge devices; and
deploying, by the one or more processors, the one or more trained models onto the one or more edge devices based on the identification in response to determining that the one or more attributes are present with the one or more edge devices.

4. The method of claim 1, wherein each of the plurality of models are trained with trends/patterns of the historic data.

5. The method of claim 1, wherein the one or more events inferenced comprise at least one of, detecting one or more anomalies with the real time data or predicting/forecasting one or more future anomalies.

6. The method of claim 1, further comprising
synchronizing, by the one or more processors, the one or more trained models deployed onto the one or more edge devices with a centralized system; and
updating, by the one or more processors, the one or more trained models with updated historic data which is retrieved from the centralized system.

7. The method of claim 6, wherein the one or more trained models are updated with the historic data in real time.

8. The method of claim 1, wherein the centralized servers are part of a sever bundle.

9. A system for performing edge level inference, the system comprising:
a training unit, configured to, train, a plurality of models with historic data of one or more resources of at least one of, centralized servers or edge servers;
a deploying unit, configured to, deploy, the one or more trained models onto one or more edge devices;
a transceiver, configured to, receive, at the one or more edge devices, real time data which is required to be inferenced; and
an inference engine, configured to, inference, utilizing the one or more trained models, at the one or more edge devices, one or more events based on the received real time data.

10. The system of claim 9, wherein the historic data pertains to at least one of, performance data, one or more resource utilizations, and trends/patterns.

11. The system of claim 9, wherein the deploying unit, deploys, the one or more trained models onto the corresponding one or more edge devices, by:
identifying by the one or more processors, one or more attributes of the historic data of the one or more trained models;
checking by the one or more processors, whether the one or more attributes of the historic data of the one or more trained models are present with the one or more edge devices; and
deploying the one or more trained models onto the one or more edge devices based on the identification in response to determining that the one or more attributes are present with the one or more edge devices.

12. The system of claim 9, wherein each of the plurality of models are trained with trends/patterns of the historic data.

13. The system of claim 9, wherein the one or more events inferenced comprise at least one of, detecting one or more anomalies with the real time data or predicting/forecasting one or more future anomalies.

14. The system of claim 9, further comprising a synchronizing unit configured to:
synchronize, the one or more trained models deployed onto the one or more ed ge devices with a centralized system; and
update, the one or more trained models with updated historic data which is retrieved from the centralized system.

15. The system of claim 14, wherein the one or more trained models are updated with the historic data in real time.

16. The system of claim 9, wherein the centralized servers are part of a sever bundle.

17. A non-transitory computer-readable medium having stored thereon computer-readable instructions that, when executed by a processor, causes the processor to perform method steps comprising:
training a plurality of models with historic data of one or more resources of at least one of, centralized servers or edge servers;
deploying the one or more trained models onto one or more edge devices;
receiving at the one or more edge devices, real time data which is required to be inferenced; and
inferencing utilizing the one or more trained models, at the one or more edge devices, one or more events based on the received real time data.
